(19) United States
(12) Patent Application Publication
(10) Pub. No.: US 2020/0242562 A1
(43) Pub. Date: Jul. 30, 2020

(54) ONLINE APPLICATION TO CENTRALIZE, CREATE, TRACK, MANAGE AND FACILITATE EMPLOYMENT APPLICATIONS FOR JOB SEEKERS

(71) Applicant: Daniel Elijah Murray, New Haven, CT (US)

(72) Inventor: Daniel Elijah Murray, New Haven, CT (US)

(21) Appl. No.: 16/370,943

(22) Filed: Mar. 30, 2019

Related U.S. Application Data
(60) Provisional application No. 62/798,192, filed on Jan. 29, 2019.

(51) Int. Cl. G06Q 10/10; G06F 16/955; G06F 16/958; G06F 17/24; G06F 3/0481

(52) U.S. Cl. CPC G06Q 10/1053; G06F 16/9562; G06F 3/0481; G06F 17/243; G06F 16/958

(57) ABSTRACT

A non-transient computer readable medium having instructions stored thereon for performing a method is described. The method includes allowing access to an online web application that centralizes, tracks, manage and facilitates the job applications process through a secure login and registration page. The method also includes providing a listing of active job applications, bookmarked jobs, and agency contacts on a user dashboard page. Further, the method includes providing a selection of resume creation forms fields for inputting information to create a resume and cover letter as well as tailored versions to a particular person and job. Further still, the method includes allowing entry of information and details related to jobs that the user has applied for to be tracked and managed by the application, and enabling sending of a job application to a prospective employer with the chosen version of the resume and cover letter via a mail form within the “Jobs Logger” application.

### REFERENCE TO RELATED APPLICATIONS

This application claims priority to U.S. Provisional Patent Application No. 62/798,192 filed on Jan. 29, 2019 to Daniel Murray, entitled WEB APPLICATION TO TRACK EMPLOYMENT APPLICATIONS AND CREATE RESUME, COVER LETTER VERSIONING, which is herein incorporated by reference in its entirety.

### BACKGROUND

Conventionally, job seekers face many inefficiencies when applying for jobs online. For example, job seekers, inefficiently, and tediously, manually create resumes and cover letters and format them using third-party word-processing applications. Job seekers often may lose track of what they may have sent to various potential employers, or what they need to send and when.

Further, job seekers are often encumbered with having to modify resume and cover letter contents to create unique, tailored versions of their resumes and cover letters for each job even when multiple jobs may be in the same general category. Further still, job seekers that are searching internet listings for work often lose track of job postings they are interested in applying for while searching, due to not having a centralized place to save them for later processing.

Accordingly, there is a need for a centralized and intuitive approach to searching and applying for jobs online. There is also a need for an efficient resume and cover letter creation process that does not require third-party word processing applications or skills, as well as a need for a centralized, user-focused online application to store, track, and manage all employment applications. Further still, there is a need for an efficient way to create, track and manage unique versions of resumes and cover letters tailored for specific jobs, as well as a need for an efficient and centralized tool for bookmarking jobs found anywhere online for later processing and pursuing. The “Jobs Logger” web application was conceived, designed and developed to solve all the above listed problems and challenges for job seekers everywhere.

### SUMMARY

An exemplary embodiment that relates to a non-transient computer readable medium having instructions stored thereon for performing a method. The method includes allowing access to an online resume and cover letter management application for tracking and facilitating job applications through a secure member login page. The method also includes providing a listing of active job applications, a listing of bookmarked jobs, and a listing of staffing agencies contacts on a user dashboard page. Further, the method includes providing a dynamic selection of resume and cover letter creation form fields for inputting information to dynamically create a formatted resume and cover letter tailored to a particular person and job. Further still, the method includes a job application tracking feature that allows entry of information and details related to a particular job that the user has applied for and enabling sending of a job application to an employer including a chosen resume and cover letter from within the application.

Another exemplary embodiment relates to a computer system having a data connection to the internet. The computer system runs an online application in a web browser to track a user's employment applications and assist a user in creating a customized resume and cover letter in the web browser on the computer system. The web application software enables the computer to perform the method including enabling the editing of the resume to coordinate with a specific job description, with the first version of the resume being the master version. The method also includes saving the first master version of the resume with other customized versions of the resume with unique names. Further, the method includes enabling the editing of the cover letter to coordinate with a specific job description. The master cover letter is a first version of the cover letter created. Further still the method includes saving the first master version of the cover letter with other customized versions of the cover letter with unique names. Yet further still, the method includes providing access to a page for applying to a prospective job, by selecting from a list of cover letters the version of cover letter for the prospective job, and selecting from a list of resumes the version of resume for the prospective job. Yet further still, the method includes sending the selected resume and cover letter over the internet to the prospective employer from within the web application.

Yet another exemplary embodiment relates to a computerized system. The computerized system includes a web server for running program steps stored thereon in a memory device, the program steps for an online resume and cover letter creation and versioning method to facilitate the centralized tracking and management of all employment applications by the user. The program steps including, allowing user access to the job applications management, tracking and assisting web application through a login page, and providing a listing of active job applications, bookmarked job listings, and staffing agencies contacts on a user dashboard page. The program steps also include providing a selection of resume creation, the selection chosen from more than one style and format of resume, the selection of resume creation enabling inputting information to dynamically create a fully formatted resume tailored to a particular person and job. Further, the method includes a job application tracking and management page that allows entry of information and details of jobs the user has applied for that is tracked and managed dynamically by the application. The method also enables a user to send a job application to a prospective employer with a chosen version of the resume and cover letter from within the application.

In addition to the foregoing, other system aspects are described in the claims, drawings, and text forming a part of the disclosure set forth herein. The foregoing is a summary and thus may contain simplifications, generalizations, inclusions, and/or omissions of detail; consequently, those skilled in the art will appreciate that the summary is illustrative only and is NOT intended to be in any way limiting, exhaustive or conclusive. Other aspects, features, methods, and advantages of the web application, devices and/or processes and/or other subject matter described herein will become apparent in the disclosures set forth herein.

### BRIEF DESCRIPTION OF THE DRAWINGS

FIG. 1 is an exemplary embodiment of a login and registration page for an online dynamic resume and cover letter creation and versioning application that tracks, manages, centralizes and facilitates the employment application process for job seekers.

FIG. 2 is an exemplary embodiment of the user dashboard page for an online dynamic resume and cover letter creation and versioning application that tracks, manages, centralizes and facilitates the employment application process for job seekers.

FIGS. 3-5 are exemplary embodiments of the resume creation and versioning pages for an online dynamic web application that tracks, manages, centralizes and facilitates the employment application process for job seekers.

FIGS. 6-8 are exemplary embodiments of the cover letter creation and versioning pages for an online dynamic web application that tracks, manages, centralizes and facilitates the employment application process for job seekers.

FIG. 9 is an exemplary embodiment of the job application tracking and management page for an online web application that tracks, manages, centralizes and facilitates the employment application process for job seekers.

FIG. 10 is an exemplary embodiment of a Job application page for an online web application that tracks, manages, centralizes and facilitates the employment application process for job seekers.

The use of the same symbols in different drawings typically indicates similar or identical items unless context dictates otherwise.

### DETAILED DESCRIPTION

Job boards and social media platforms only provide one specific component of the job application process for job seekers. These platforms offer either limited job posting abilities to employers or allow job seekers to apply for jobs via their social media profiles, which are incomplete, unprofessional and unreliable. The other option is that job seekers have to apply via the manual and tedious process of sending unique emails with file attachments from their computers, which become difficult to track and manage over time.

In accordance with an exemplary embodiment, the disclosed online web application is a major improvement to the job application process. The disclosed software application provides job seekers with a single online application that centralizes and facilitates all their job seeking efforts. The web application allows job seekers to create a master version as well as unique versions of their resumes or curriculum vitae (CVs) and to track and manage all jobs applied for as well as bookmarking jobs they intend to apply for in the future. The disclosed software application, which in an exemplary embodiment is a web application, has the express purpose of centralizing the job application process for job seekers via a cloud-based solution, which can be accessed from anywhere and on any device with an internet connection. The exemplary software application eliminates the need to search for files (such as, but not limited to resumes, CVs, and cover letters) on personal computers and other devices, which is tedious and time-consuming and could lead to missed employment opportunities.

In accordance with various exemplary embodiments, the software application can produce and create customized resume and CV templates. The exemplary embodiments of the application may also facilitate the creation of customized cover letter templates. Further, exemplary embodiments of the application enable dynamic formatting and styling of resumes, CVs, and cover letters from a master template. In exemplary embodiments the software application enables the creation of Adobe PDF documents and Microsoft Word documents, (both of which are third party file formats not affiliated with the exemplary embodiments of the application) and the like. Further still, an exemplary embodiment enables the generation of data analytics to identify user trends via the user dashboard.

In accordance with an exemplary embodiment, the application centralizes data and files that a job seeker needs to apply for jobs online. Each part of the application collects specific information that is stored in a database and is used dynamically to build the user dashboard, the Resume/CV template, the Cover Letter template, to track and manage each job applied for, and to apply for jobs from within the application by choosing files from a dropdown list of files and submitting them via an email form.

The main steps in the process of using the software application may be, for example (1) Sign-in or Register and Subscribe, (2) access a User Dashboard, (3) create a Resume or CV, (4) create a cover letter, (5) manage and track applications, and (6) apply for jobs.

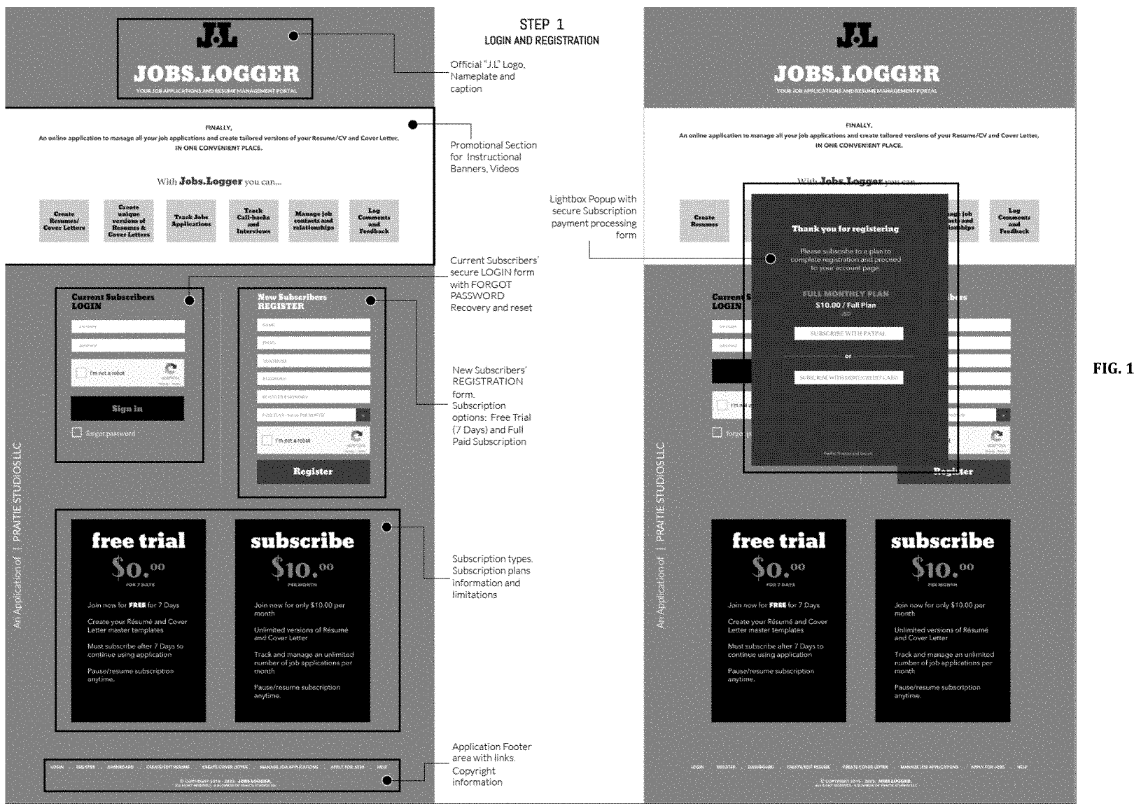

Referring now to FIG. 1, a Sign-in/Registration and Subscription page is depicted and is the first element of the application where all users must create an account and subscribe to the service. An existing user must sign-in to access their dashboard and manage their account. A user can change passwords, suspend/resume their subscriptions and contact us for technical support.

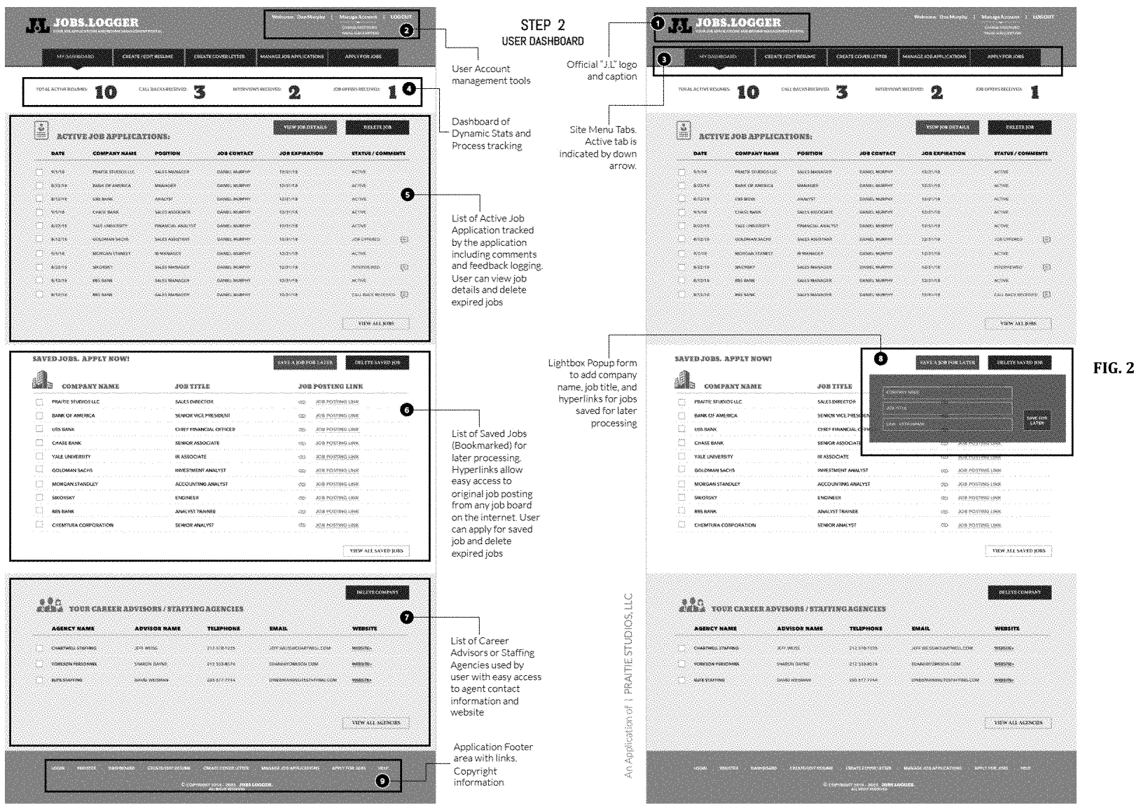

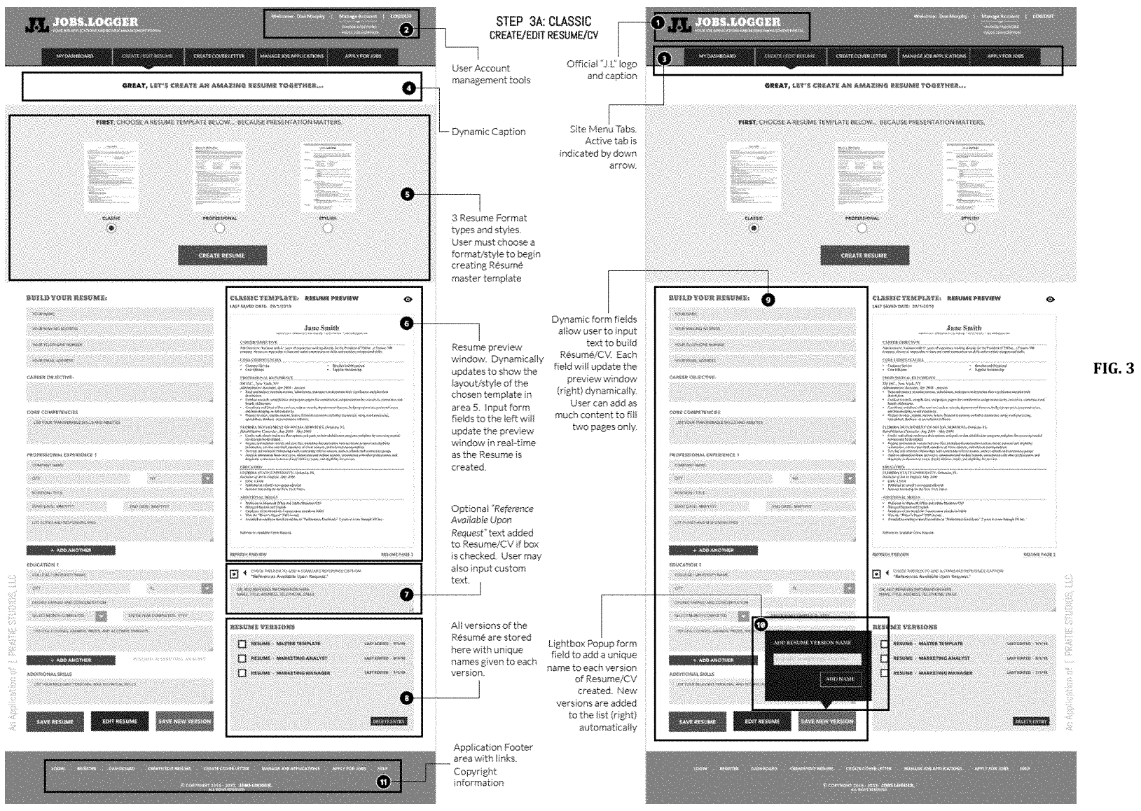

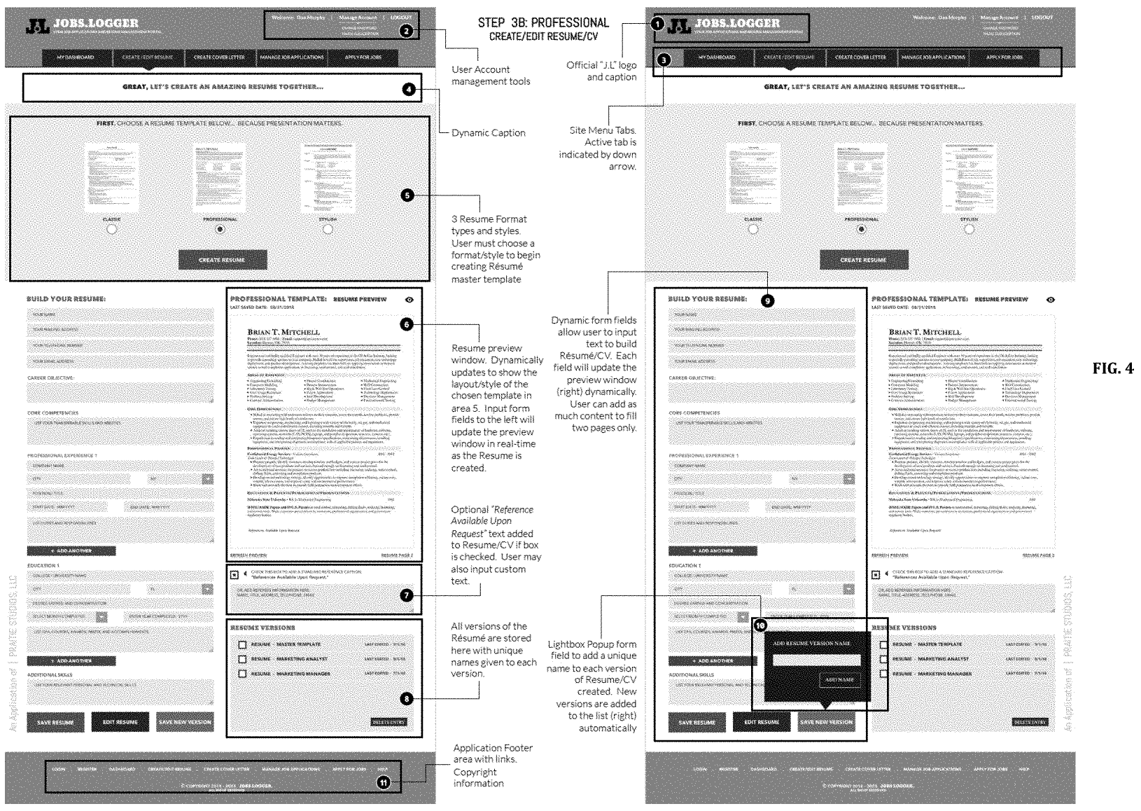

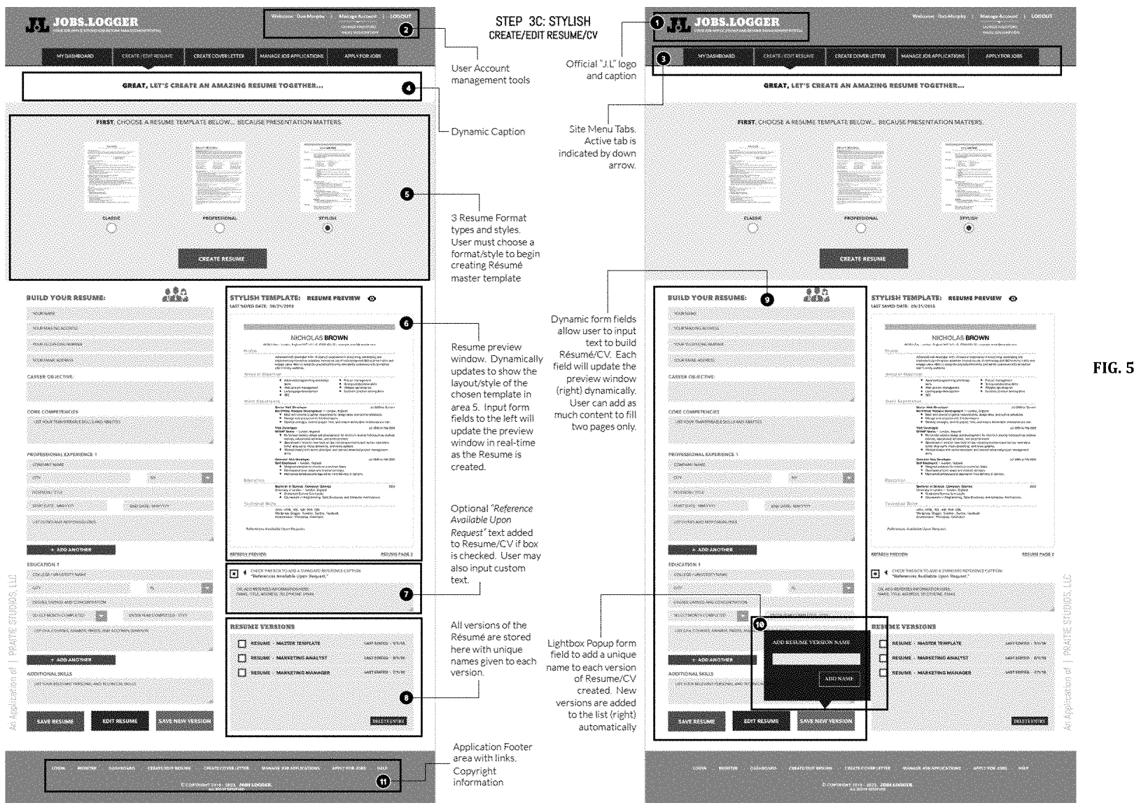

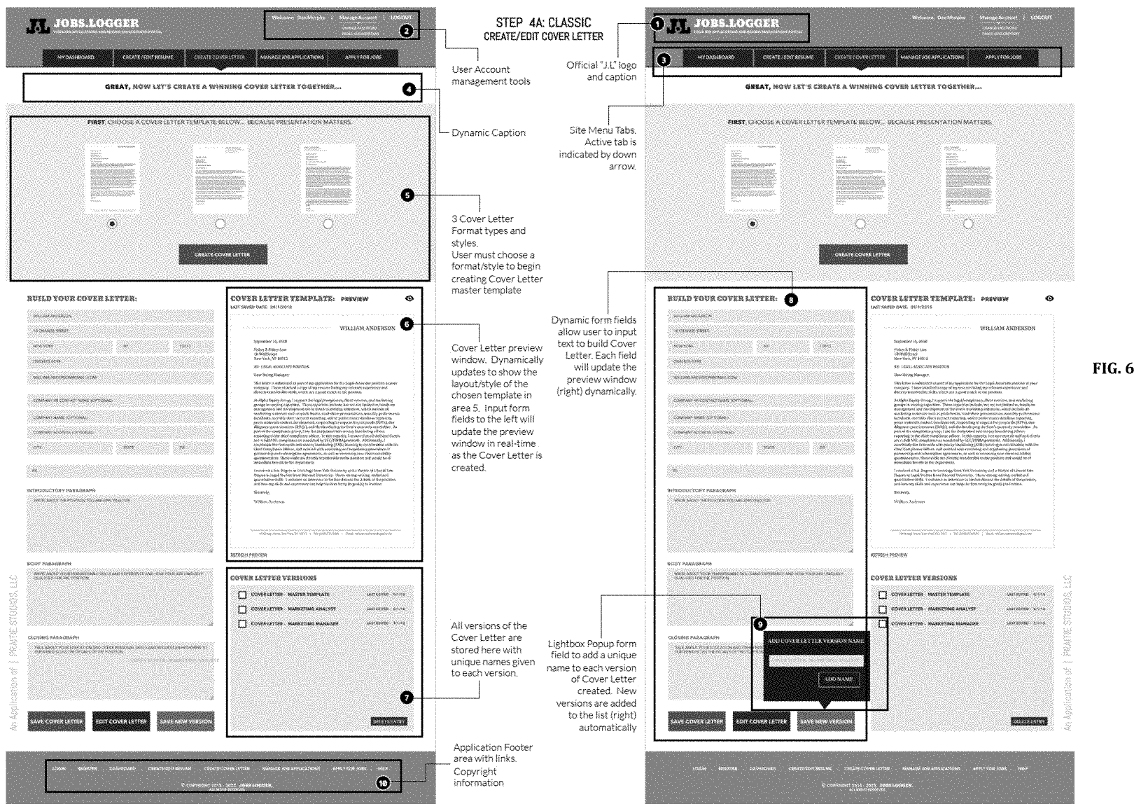

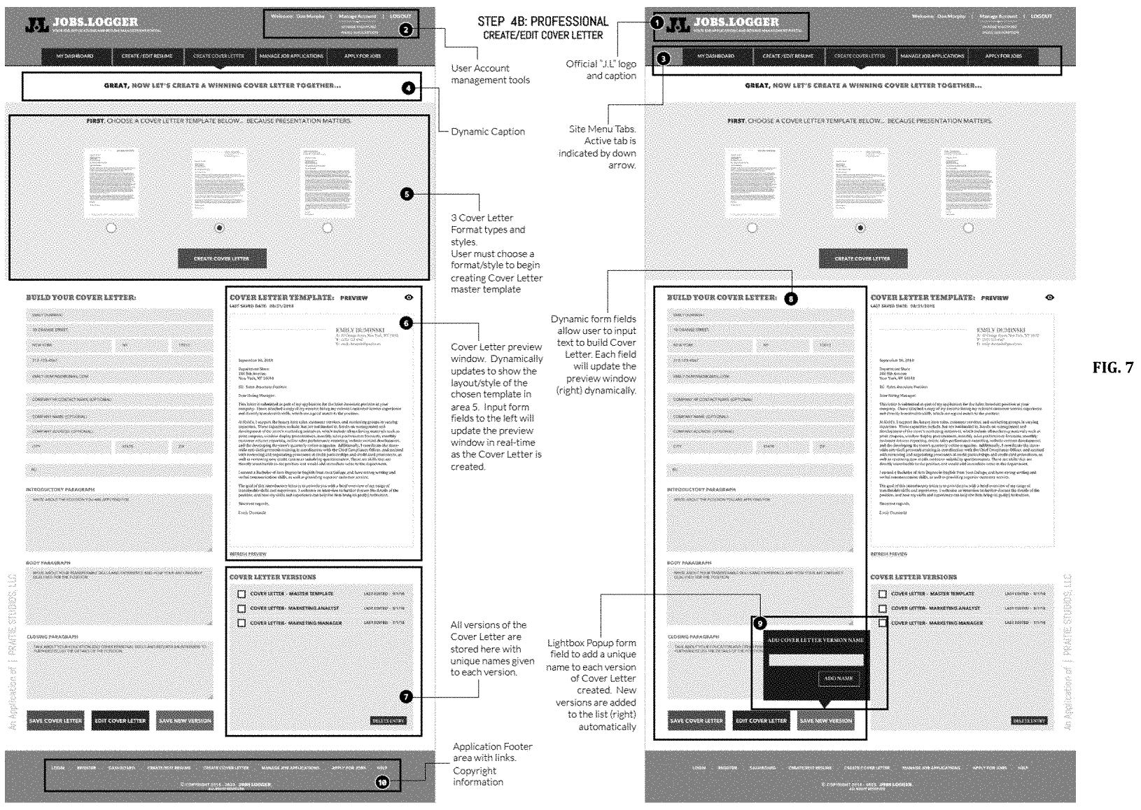

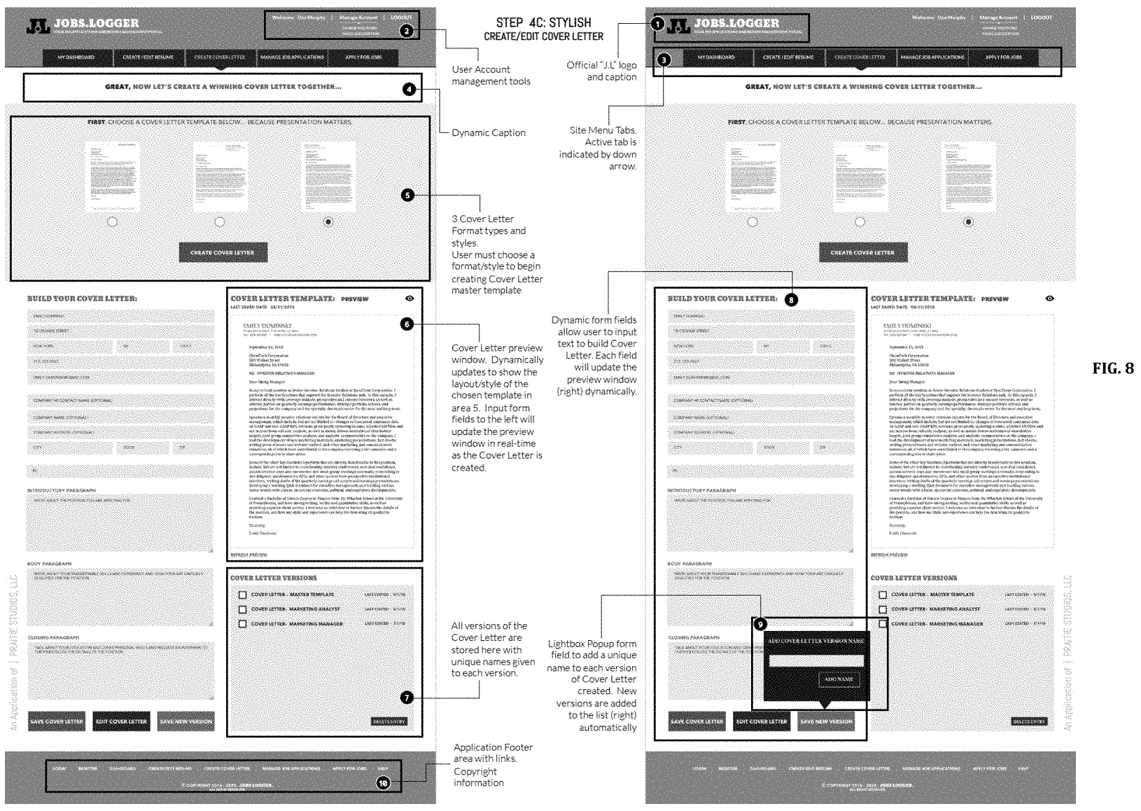

From the account page, the user is taken to the Dashboard page as depicted in FIG. 2. Here the user is presented with a selection of metrics of all active jobs applied for, all expired jobs (by date), callbacks received, interviews attended, and job offers received. On this page, the user is also able to bookmark jobs for later by adding hyperlinks to job postings from anywhere. Both the Create Resume/CV and Cover Letter pages will require data input to build the dynamically formatted master template for each. These areas have both required and optional data fields. From these pages, the user is able to create/edit unique versions of both the Resume/CV and Cover Letter for each job (FIGS. 3-8). Each unique version will require a unique name and is added to a dropdown list from which the user will select as needed.

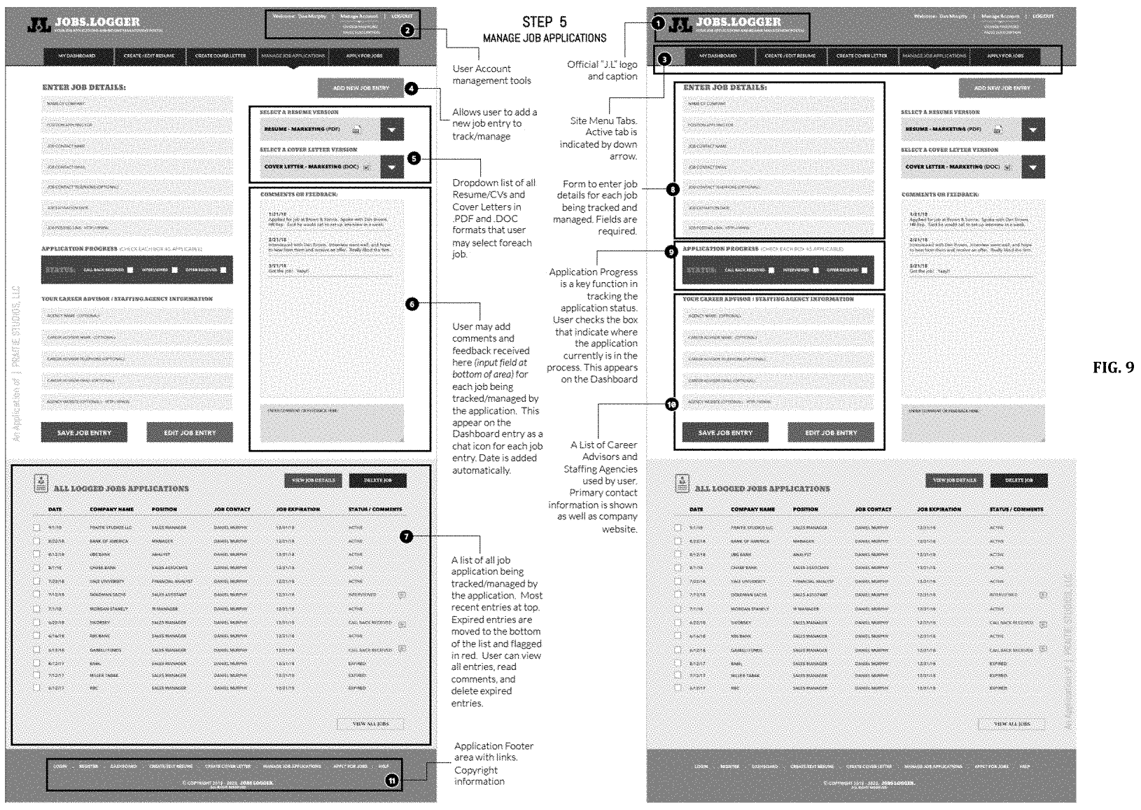

The job application tracking and management page, as depicted in FIG. 9, will require the user input details about each job they applied for. This will be added to the active jobs list on the dashboard and can be edited at any time to track the status. This area also has required and optional fields. Users can enter as many jobs for tracking as allowed by their subscription plan.

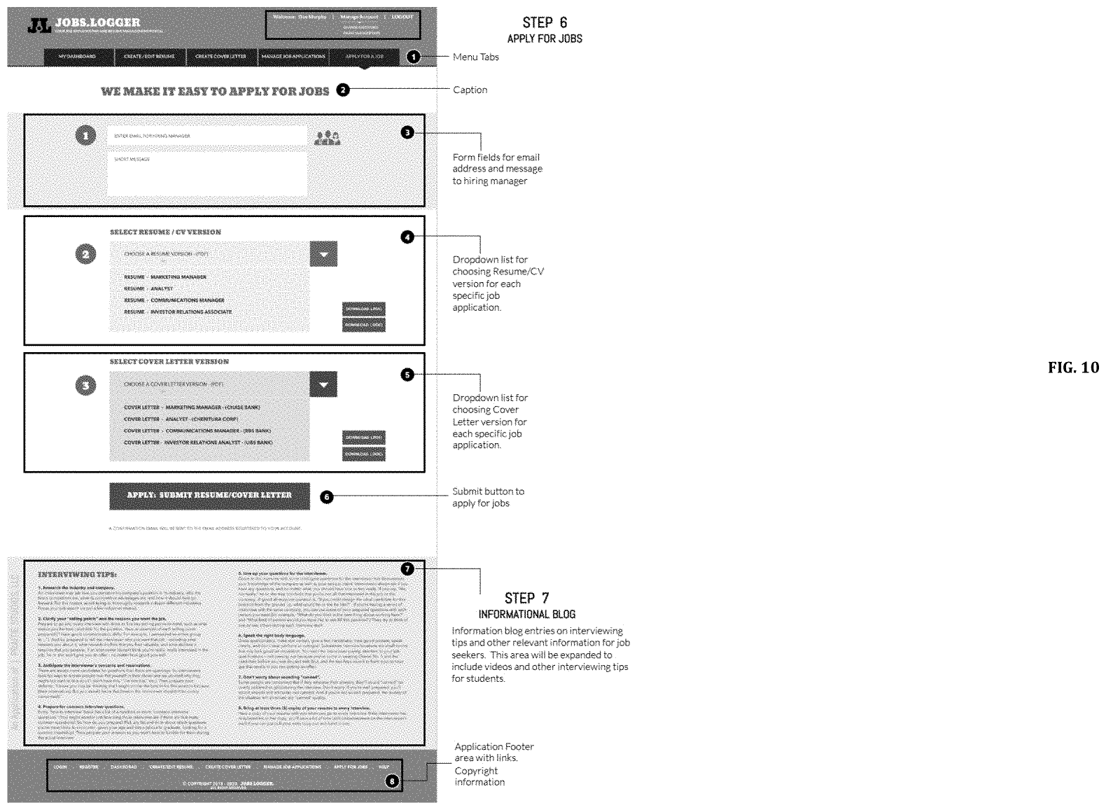

From the Apply for Jobs page, as depicted in FIG. 10, the user is able to apply for a job by entering the email address of the specific company contact, add a message, then choose a file from the dropdown lists for the Resume/CV and Cover Letter in .PDF or .DOC formats and submit via the in-app form. A copy of the application message is sent to both the company and the applicant.

General interviewing tips and information are provided as a blog on the site to provide useful information to help the user be successful during the interviewing process. The Blog area will also include videos contents by experts on career and interviewing trends in the future.

Once the user is logged in, they must personally create/edit/version their CV and Cover Letter to each job they intend to apply for. Creating a new Resume/CV will require input of data and will need to follow prompts to add additional information via the dynamic forms in the app. Editing and Versioning of Resume/CV and Cover Letter template will require tailoring each document to the requirements of each job. They will also need to input the details of each job to be tracked and managed by the application via a dynamic form. The application also allows them to bookmark jobs for future processing.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A non-transient computer readable medium having instructions stored thereon for performing a method, the method comprising:
allowing access to an online web application that centralizes, tracks, manage and facilitates the job applications process through a secure login page;
providing a listing of active job applications, bookmarked jobs, and agency contacts on a user dashboard page;
providing a selection of resume templates and form fields for inputting information to create a master resume as well as create customized versions to a particular person and job;
providing a selection of cover letter templates and form fields for inputting information to create a master cover letter as well as create customized versions to a particular person and job;
allowing entry of information and details related to a particular job that the user has applied for to be tracked and managed by the application; and
enabling sending of a job application to a prospective employer with the chosen version of the resume and cover letter via a mail form in the app.

2. The method of claim 1, wherein the dashboard page includes a listing of saved job postings, each of the job postings includes a link to the referring job posting page online.

3. The method of claim 1, further comprising:
providing a selection of cover letter styles for inputting information to create a master cover letter template as well as tailored versions to a particular person and job.

4. The method of claim 3, further comprising:
storing and listing more than one version of the cover letter tailored to the particular person and job.

5. The method of claim 1, wherein the resume selection includes a choice from at least three different styles of resume.

6. The method of claim 1, further comprising:
listing all jobs for which the information and details related to the particular job have been entered.

7. The method of claim 1, further comprising:
providing a selection of job application progress.

8. The method of claim 1, further comprising:
selecting, prior to sending the job application, a resume version and a cover letter version from a list of resume versions and cover letter versions.

9. A computer system having a data connection to the internet, the computer system running software to track a user's employment searching and assist a user in creating a customized resume and cover letter on the computer system the software enabling the computer to perform the method comprising:
enabling the editing of the resume to coordinate with a job description, the master resume being a first version of the resume;
saving with unique names the first version of the resume with other versions of the resume;
enabling the editing of the cover letter to coordinate with a job description, the master cover letter being a first version of the cover letter;
saving with unique names the first version of the cover letter with other versions of the cover letter;
providing access to a page for selecting a prospective job;
selecting from a list of cover letters the version of cover letter for the prospective job;
selecting from a list of resumes the version of resume for the prospective job; and
sending the selected resume and cover letter over the internet to the prospective employer.

10. The method of claim 9, further comprising:
providing a selection of cover letter styles for inputting information to dynamically create a fully formatted cover letter tailored to a particular person and job.

11. The method of claim 9, further comprising:
providing a selection of resume styles for inputting information to dynamically create a fully formatted resume tailored to a particular person and job.

12. The method of claim 9, further comprising:
listing all jobs for which the information and details related to the particular job have been entered to be managed and tracked.

13. The method of claim 9, further comprising:
providing a selection of job application progress.

14. The method of claim 9, further comprising:
allowing user access to use the web application through a secure login page to a user account.

15. A computerized system comprising:
a secure cloud-based web server for running program steps stored thereon in a memory device, the program steps to centralize, track, manage, and facilitate the job application process, the program steps including:
allowing user access to the web application through a secure login and registration page;
providing a listing of active job applications, bookmarked jobs, and agency contacts on a user dashboard page;
providing a selection of resume creation, the selection chosen from more than one style and format of resume, the selection of resume creation enabling inputting information to create a master resume as well as tailored versions to a particular person and job;
allowing entry of information and details of jobs that the user has applied for to be tracked and managed by the application; and
enabling sending of a job application to a prospective employer including the chosen versions of the resume and cover letter.

16. The computer system of claim 15, having program steps further comprising:
enabling the versioning of the resume to coordinate with a job description, the master resume template being a first version of the resume.

17. The computer system of claim 16, having program steps further comprising:
saving the first master version of the resume with other unique versions of the resume.

18. The computer system of claim 15, having program steps further comprising:
enabling the versioning of the cover letter to coordinate with a job description, the master cover letter being a first version of the cover letter.

19. The computer system of claim 18, having program steps further comprising:
saving the first master version of the cover letter with other unique versions of the cover letter.

20. The computer system of claim 15, having program steps further comprising:
providing access to a page for selecting a prospective job; and
selecting from a list of cover letters a chosen version of cover letter for the prospective job; and
selecting from a list of resumes a chosen version of resume for the prospective job.
